(19) United States
(12) Patent Application Publication
(10) Pub. No.: US 2022/0212088 A1
(43) Pub. Date: Jul. 7, 2022

(54) ROVINGS AND FABRICS FOR FIBER-REINFORCED COMPOSITES

(71) Applicant: PDA ECOLAB, SAS, Meylan (FR)

(72) Inventor: Lance JOHNSON, Meylan (FR)

(21) Appl. No.: 17/608,036

(22) PCT Filed: Apr. 4, 2020
(86) PCT No.: PCT/IB2020/000401

§ 371 Date: Nov. 1, 2021

Related U.S. Application Data
(60) Provisional application No. 62/841,266, filed on May 1, 2019.

(51) Int. Cl. A63C 5/03; B32B 5/08; B32B 5/10; B32B 5/26; B32B 5/02

(52) U.S. Cl. CPC A63C 5/03; B32B 5/08; B32B 5/10; B32B 2260/046; B32B 5/022; B32B 2262/06; B32B 2260/021; B32B 5/265

(57) ABSTRACT

The present disclosure relates to a roving or fabric for a fiber-reinforced composite, comprising:—natural or synthetic fibers or rovings (104); and—one or more cork threads (102).

This application claims the priority benefit of U.S. provisional patent application No. 62/841,266, the content of which is hereby incorporated by reference in its entirety to the maximum extent allowable by law.

### TECHNICAL FIELD

The present disclosure relates generally to the field of fiber or fabric reinforced composites, and in particular to a roving, a tow, or a fabric for a use in a fiber-reinforced composite, and to the resulting compositions.

### BACKGROUND

Each year millions of kilograms of carbon fiber, fiberglass, flax fiber, basalt fiber, and other fibers with advantageous tensile, compressive and/or flexural strengths are produced for use as reinforcement materials in Fiber-Reinforced Composites, or FRCs (which may also be synonymously referred to as Fiber-Reinforced Plastics, or FRPs). These reinforcement fibers are combined with Thermoset or Thermoform plastic resins (collectively referred to as the Matrix) to create structural materials with superior properties to the separate components.

In a structure where light-weight design is prized, using materials with a high strength-to-weight ratio is favored. While this is an efficient use of the materials, it can also result in undesirable characteristics, particularly with regard to acoustic-, vibration-, and rebound-damping. If an excessive amount of shock or vibration is transmitted through a structure, or if the rebound rate of the structure under a deforming load is too aggressive, this can have negative effects on the performance of the structure.

In buildings, automobiles, and sporting goods (among other examples), the damping of sound and vibration is often desirable, and sometimes vital.

In order to tailor the properties of high strength-to-weight materials, hybridized constructions are often created using base materials of varying types and properties. Elastomeric strands may be woven into a reinforcement fabric; thin layers of viscoelastomeric material may be situated in a thermoset FRC between layers of reinforcing fabric; or multiple fiber types such as plies of carbon alternated with plies of flax and/or plies of basalt may be used in a layup to improve the vibration damping of a rigid FRC and/or moderate the flexural rebound rate.

Current solutions to enhance damping are expensive, for example due to additional steps in the construction process, e.g. adding separate plies of viscoelastomer into a layup increases the cost of a finished part. Furthermore, elastomers and other damping agents added to FRCs are typically petroleum-based and therefore they are harmful to the environment.

There is thus a need in the art for an improved reinforcement fiber construction and reinforcement fabric composition providing effective damping without relying on damping agents based on petroleum or other non-renewable resources.

### SUMMARY OF INVENTION

Embodiments of the present disclosure aim to at least partially address some or all of the needs in the prior art.

One aspect of the present disclosure consists of at least one cork-based thread incorporated into a roving (or bundle) of fiber, which is used in total or in part to form the reinforcement element of an FRC.

A “cork thread” is any construction of cork having a diameter that is for example of less than two millimeters, and a length that is for example greater than 2000 millimeters. The thread may be steam-welded, bonded with natural adhesives, or structurally reinforced in such way as to provide a tensile strength suitable for allowing the cork thread to be combined with other reinforcing fibers.

The cork thread may be located within the roving and other reinforcing fibers arranged around it; or the cork thread may be randomly or non-randomly tangled with other reinforcing fibers comprising the roving; or it may be laid astride the roving.

The rovings may then be utilized in a process such as filament winding or incorporated as unidirectional reinforcement tape in a matrix, or may be incorporated as tows into a braided, woven, or stitched fabric in a multiaxial or unidirectional construction. While the words “roving” and “tow” are generally understood to be synonymous, for purposes of clarity, we use “roving” in this application to refer to the stand-alone bundle of fibers, and “tow” to refer to a roving that is woven or stitched together to form a fabric.

The rovings may be formed using any synthesized fibers, such as carbon, glass, boron, aramid, etc., or any natural fibers, such as bamboo, flax, hemp, etc.), or any other reinforcement that is or may become commonly used in the composites industry.

The rovings and/or fabrics may be combined with any thermoset or thermoform resin system to form an FRC.

The rovings may be created having more than one cork thread.

Tows may be incorporated into a fabric in such a way that at least one tow in at least one axis utilizes the “tow with cork thread.”

Cork threads may be incorporated into a stitched, woven or braided fabric separate from a fiber tow, or a tow may be created using exclusively cork threads and incorporated into a fabric with reinforcement fiber tows (which may either have or not have a cork thread).

Rovings, tows and fabrics created from the tows may have resins, resin-based filaments (such as Poly-lactic-acid or Polyamide), or other additional chemistry or structural agents (metal filaments or other reinforcements) added to tailor the performance of the resulting FRC.

According to one aspect, there is provided a roving or fabric for a fiber-reinforced composite, comprising: natural or synthetic fibers or rovings; and one or more cork threads.

According to one embodiment, the one or more cork threads each have a diameter or width of less than 2 mm.

According to one embodiment, the one or more cork threads each have a length greater than 2000 mm, prior to cutting to form a fiber-reinforced composite layup.

According to one embodiment, the fibers or tows are formed of natural fibers, such as fibers of ramie, bamboo, pineapple leaf, flax, or hemp.

According to one embodiment, a volumetric percentage of the cork thread in the roving is in the range 25% to 85%.

According to one embodiment, a volumetric percentage of the cork thread in the fabric is in the range 1% to 50%, and more preferably in the range 5% to 25%.

According to one embodiment, the fabric comprises the natural or synthetic rovings woven with the one or more cork threads.

According to a further aspect, there is provided a fiber-reinforced composite layup comprising the above roving or fabric.

According to one embodiment, the one or more cork threads is surrounded by natural or synthetic fibers.

According to one embodiment, the one or more cork threads is at least partially disposed at an edge of the roving.

According to one embodiment, the one or more cork threads is tangled with the natural or synthetic fibers.

According to a further aspect, there is provided a fiber-reinforced composite comprising the above fiber-reinforced composite layup, combined with a thermoset or thermoform resin.

According to a further aspect, there is provided a sliding board having a ply formed of the above fiber-reinforced composite.

According to yet a further aspect, there is provided a hand-held pole comprising a shaft formed of the above fiber-reinforced composite.

According to a further aspect, there is provided a method of forming a roving or fabric for a fiber-reinforced composite comprising: incorporating one or more cork threads into a roving or fabric comprising natural or synthetic fibers or rovings.

According to yet a further aspect, there is provided a method of forming a fabric for a fiber-reinforced composite, comprising: forming at least one roving according to the method above; and pre-impregnating the at least one roving with an epoxy resin, and arranging the at least one roving, possibly with further rovings, upon a backing paper or support to form the fabric.

According to one embodiment, the fabric is a unidirectional fabric, and the method further comprises forming one or more further unidirectional fabrics, and assembling the unidirectional fabrics to form a multi-axial fabric.

According to one embodiment, arranging the at least one roving, possibly with other rovings, upon the backing paper comprises tangling the rovings together to form a non-woven fabric.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 illustrates, in cross-section and side profile, a roving for a reinforcement element comprising a central cork thread surrounded by other fibers according to an example embodiment of the present disclosure;

FIG. 2 illustrates, in cross-section and side profile, a roving for a reinforcement element comprising a cork thread astride other fibers according to an example embodiment of the present disclosure;

FIG. 3 illustrates, in cross-section and side profile, a roving for a reinforcement element comprising a cork thread tangled in other fibers according to an example embodiment of the present disclosure;

FIG. 4 is a flow diagram representing an example of steps in a method of forming a cork thread according to an example embodiment of the present disclosure;

FIG. 5 illustrates a unidirectional reinforcement fabric comprised of fiber-reinforcement tows utilizing at least one cork thread according to an example embodiment of the present disclosure;

FIG. 6 illustrates a unidirectional stitched fabric comprised of fiber-reinforcement tows utilizing at least one cork thread according to an example embodiment of the present disclosure;

FIG. 7 illustrates a multi-axial stitched fabric comprised of fiber-reinforcement tows utilizing at least one cork thread according to an example embodiment of the present disclosure;

FIG. 8 illustrates a multi-axial woven fabric comprised of fiber-reinforcement tows utilizing at least one cork thread according to an example embodiment of the present disclosure;

FIG. 9 illustrates a tubular braid comprised of fiber-reinforcement tows utilizing at least one cork thread according to an example embodiment of the present disclosure;

FIG. 10 illustrates a unidirectional fabric comprising alternating tows of reinforcement fiber situated astride tows of cork thread according to an example embodiment of the present disclosure;

FIG. 11 illustrates a biaxial fabric comprising alternating tows of reinforcement fiber situated astride tows of a cork thread according to an example embodiment of the present disclosure;

FIG. 12 illustrates a 2×1 twill fabric comprising alternating tows of reinforcement fiber situated astride tows of a cork thread according to an example embodiment of the present disclosure;

FIG. 13 illustrates a plain weave fabric comprising alternating tows of reinforcement fiber situated astride tows of a cork thread according to an example embodiment of the present disclosure;

FIG. 14 illustrates boards of skis comprising a reinforcement fabric composition containing cork thread according to an example embodiment of the present disclosure; and

FIG. 15 illustrates a shaft of a ski or walking pole comprising a reinforcement fabric composition containing cork thread according to an example embodiment of the present disclosure.

### DESCRIPTION OF EMBODIMENTS

Like features have been designated by like references in the various figures. In particular, the structural and/or functional features that are common among the various embodiments may have the same references and may dispose identical structural, dimensional and material properties.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

While the terms “roving” and “tow” are generally understood to be synonymous, for purposes of clarity, we use “roving” herein to refer to the stand-alone bundle of fibers, and “tow” to refer to a roving that is woven or stitched together to form a fabric.

### First Aspect—Roving or Fabric Containing Cork Thread

FIG. 1 illustrates a cross-section A-A, and a side profile, of a roving 100 for a reinforcement element. A place where the cross-section A-A is taken is represented in the profile view of FIG. 1.

As known by those skilled in the art, in the field of composite materials, a roving is a bundle of filaments that is incorporated into the composite material in order to improve the mechanical properties of the composite material, such as increasing the strength of the composite in at least one axis. In some cases, the rovings described herein are cut and assembled to form a layup for an FRC, which is then incorporated into the FRC. In other cases, the rovings described herein are used as tows that are arranged together and stitched or woven in order to form a fabric, which orients multiple tows of reinforcement material in specific axes. A tape could also be formed, for example by using an adhesive to adhere rovings together, without inhibiting the pliability of the tape. This fabric or tape is for example cut and assembled to form a layup for an FRC, which is then incorporated into the FRC. For example, the rovings described herein could be incorporated into a fiber-reinforced plastic comprising thermoset or thermoform plastic resin to form the Matrix of the FRC material, or in other types of composites.

The roving 100 comprises a bundle of fibers, comprising at least one a cork thread 102, and a plurality of reinforcement fibers 104.

The cork thread 102 for example has a width or diameter d greater than 0.25 mm and for example of less than 2 mm. In the example of FIG. 1, the cork thread is substantially square in cross-section. In alternative embodiments, other cross-section forms would be possible, including rectangular, polygonal, oval, and circular.

The cork thread 102 for example has a length l that is substantially equal to the length of the reinforcement fibers, and/or for example that is greater than 2000 mm in the roving 100. For example, the cork thread 102 may be provided on a spool. The roving 100 may then be cut to a shorter length prior to being incorporated into a layup for an FRC, the length of which will depend on the application.

The reinforcement fibers 104 are for example synthesized fibers, such as fibers of carbon, glass, boron or aramid; or natural fibers, such as vegetal fibers of bamboo, flax, ramie, hemp, sisal, jute, banana, pineapple leaf, coir, abaca, rice, corn and nanocellulose, such as mineral fibers of basalt, asbestos, and ceramic fibers, and such as animal derived fibers of goat hair, horse hair, lamb wool, and silk. In some embodiments, the natural fibers are organic fibers, or vegetable-derived fibers. Other types of fibers that are or may become commonly used in the composites industry could also be used. The reinforcement fibers 104 for example have a width or diameter d′ less than the diameter of the cork thread 102, and/or of less than 1 mm, and for example greater than 1 μm.

In the example of FIG. 1, the cork fiber 102 is positioned centrally in the roving 100, and the reinforcement fibers 104 surround the cork fiber 102. For example, the roving 100 comprises eight reinforcement fibers surrounding the cork fiber 102. More generally, the number n of reinforcement fibers surrounding the cork thread 102 could be between 1 and several thousand, depending on their respective dimensions, and on the particular application.

An advantage of incorporating a cork thread into a roving of a reinforcement element, as shown in FIG. 1, is that the cork thread 102 provides a damping function, thereby damping vibrations passing through the composite material and damping the rebound rate of the composite material formed using the roving 100. For example, such a damping function is particularly apparent when the volumetric percentage of cork thread in the roving is in the range of 25% to 85%, and if incorporated into a fabric, the volumetric percentage of cork thread in the fabric is for example in the range 1% to 50%, and more preferably in the range 5% to 25%. A further advantage of incorporating a cork thread 102 as depicted in roving 100 is that the cork thread is significantly strengthened and protected during the construction process of either a finished composite part, or of a composite reinforcement fabric.

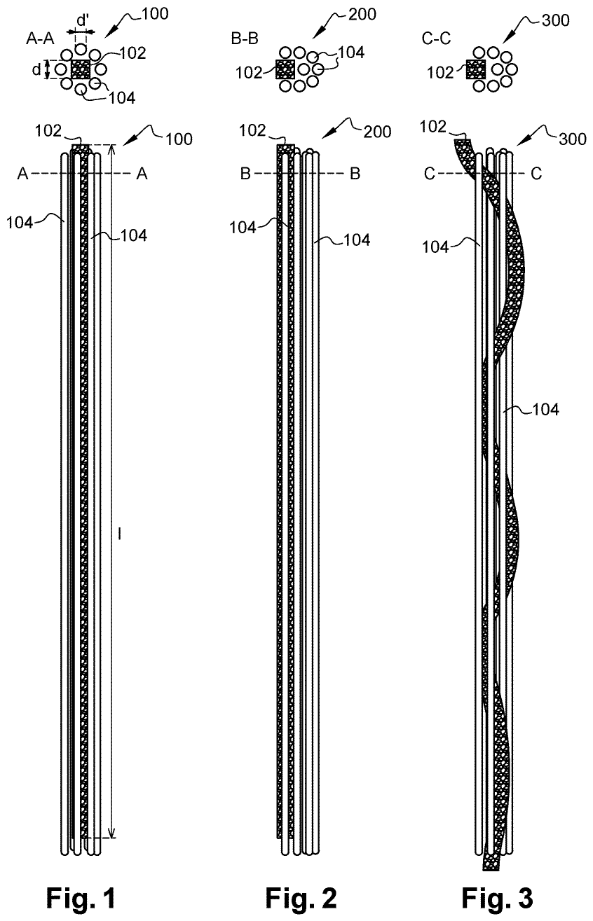

FIG. 2 illustrates a cross-section B-B, and a side profile, of a roving 200 for a reinforcement element comprising the cork thread 102 and the reinforcement fibers 104. A place where the cross-section B-B is taken is represented in the profile view of FIG. 2. The cork thread 102 and reinforcement fibers 104 are for example the same as those described in relation with the example of FIG. 1, and will not be described again in detail.

In the example of FIG. 2, the cork thread 102 is positioned off-center within the bundle of fibers forming the roving 200. For example, the cork thread 102 is positioned astride the roving. In some embodiments, at least one edge of the cork thread 102 is disposed at an edge of the roving 200.

An advantage of the embodiment of FIG. 2 is a reduction in fabrication costs, as the cork thread 102 does not require careful positioning within the center of the roving during construction. Furthermore, where such a tow is incorporated into a woven or stitched fabric, such an embodiment may advantageously provide damping between the tows when at least some of the contact points between the tows involve a contact with one or more cork threads.

FIG. 3 illustrates a cross-section C-C, and a side profile, of a roving 300 for a reinforcement element comprising the cork thread 102 and the reinforcement fibers 104. A place where the cross-section C-C is taken is represented in the profile view of FIG. 3. The cork thread 102 and reinforcement fibers 104 are for example the same as those described in relation with the example of FIG. 1, and will not be described again in detail.

In the example of FIG. 3, the cork thread 102 meanders through the bundle of reinforcement fibers 104 forming the roving 200. For example, the cork thread 102 is randomly or non-randomly tangled or intertwined with the reinforcement fibers 104.

An advantage of such a tangled disposition of the cork thread 102 is that, when the reinforcement fibers 104 are finite-length reinforcement fibers such as natural fibers (flax, ramie, bamboo, etc.), such fibers are able to create interlocking tangles with each other, which increase the tensile strength of the roving. Furthermore, the number of reinforcement fibers contacted by the cork thread 102 is increased, improving the distribution of the damping function throughout the roving. Further still, in a similar fashion to the example of FIG. 2, at least one edge of the cork thread 102 is for example regularly or irregularly disposed at the edges of the roving 300. This cork present at the edges of the roving will for example contact the other materials forming the composite, thereby aiding damping. Where such a tow is incorporated into a woven fabric, such an embodiment may also advantageously provide damping between the tows.

While FIGS. 1, 2 and 3 represent examples in which there is a single cork thread in each roving 100, 200, 300, in alternatively embodiments, these roving could comprise more than one cork thread 102, such as two or more cork threads 102.

The roving of FIG. 1, 2 or 3 is for example used as part of a layup for an FRC, the layup corresponding to an assembly of components for forming the FRC prior to curing. One or more of the rovings are for example combined with any thermoset or thermoform resin system to form an FRC, or they can be used as a tow that is woven or assembled to form a fabric that can then be combined with any thermoset or thermoform resin system to form an FRC. In some embodiments, the rovings, tows, or fabrics created from the tows, have resins, resin-based filaments, such as Poly-lactic-acid (PLA) or Polyamide (PA), or other additional chemistry or structural agents, e.g. metal filaments or other reinforcements, added in order to tailor the performance of the resulting composite.

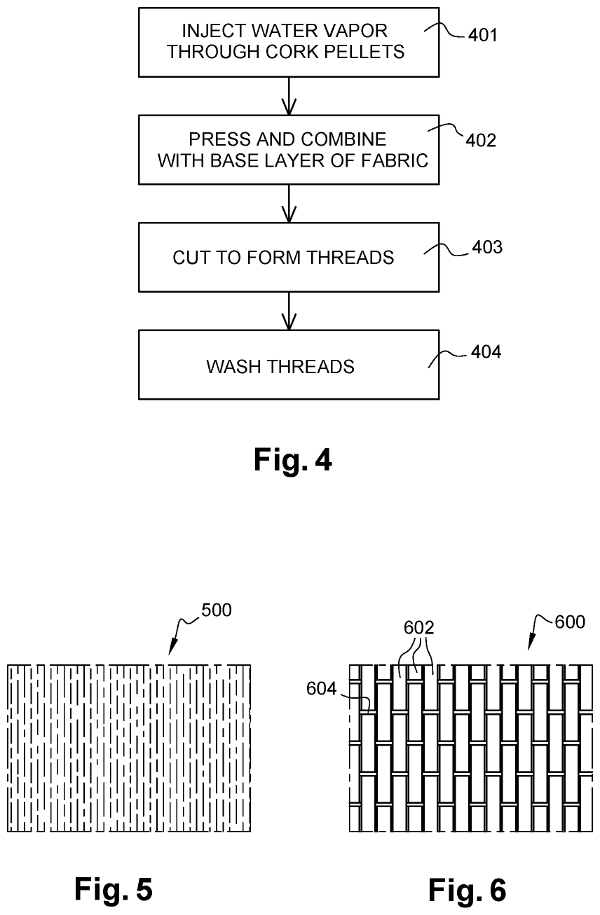

Cork thread of the type described above is for example fabricated using any of a number of known processes for forming cork thread. For example, one such process is described in the PCT patent application published as WO 2018/063018, the contents of which is hereby incorporated by reference to the extent permitted by the law. Another example of a suitable process will now be described with reference to FIG. 4.

FIG. 4 is a flow diagram representing an example of steps in a method of forming a cork thread according to an example embodiment of the present disclosure.

In a step 401, water vapor is for example injected through cork pellets, thereby causing the cork pellets to expand, the water bonding to the resin in the cork.

In a step 402, the mixture is then for example pressed and combined with a base layer, such as a layer of Flax, Ramie, PLA, PHA (Poly-hydroxy-alkanoates), Polyamide or Polyester, or other type of material. This results in a relatively thin sheet, the thickness of which is for example chosen based on the desired thickness of the cork thread.

In a step 403, the sheet produced in operation 402 is then for example cut into strips, the width of each strip for example being chosen based on the desired width of the cork thread.

Alternatively, and based on the dimension of the base layer in step 402, the dimension of the resulting cork/base structure created in step 402 may be of an appropriate dimension whereby the cutting into strips described in step 403 is not required to arrive at the final specified dimension for use in rovings, tows, or fabrics.

In some embodiments, in a step 404, the threads resulting from step 403 are then washed in a solution including, but not limited to, a starch-based solution, and/or an alkali solution, and/or a weak acidic solution, in order to increase strength, flexibility, and/or elasticity. Additionally, or alternatively, the thread may be steam-welded, bonded with natural adhesives, or further structurally reinforced prior to use.

One or more of the rovings as described in relation with FIGS. 1, 2 and 3 can be used as a tow to form a fabric, as will now be described in relation to FIGS. 5 to 9.

FIG. 5 illustrates a unidirectional reinforcement fabric 500 comprising tows, at least one of which corresponds to a tow containing cork thread, such as in the examples of FIGS. 1, 2 and 3, and according to an example embodiment of the present disclosure. The example of FIG. 5 is a non-stitched fabric. In one embodiment, to form such a fabric, the tows are pre-impregnated with an epoxy resin and are arranged astride each other and upon a backing paper or support. A removeable film is for example used to cover the surface opposite the backing paper and is removed when the fabric is used to create an FRC. Once the exposed fabric face has been adhered to either a mold or another layer of composite reinforcement fabric, the backing paper is removed.

While in the example of FIG. 5 the tows are aligned in a single axis, it would also be possible to form a fabric using a similar technique, but in which a non-woven matt is formed in which the tows containing cork thread are tangled together, like in the roving 300, and without a precise orientation.

Furthermore, the above method for forming the fabric 500 could be adapted to form a multi-axial fabric. For example, the pre-pregged ply is layed upon a second, and possibly a third pre-pregged plies formed in a similar manner to the first ply, where the pre-pregged plies of each layer have their tows arranged in different orientations. The sandwich of plies is then for example covered with the protective film and the fabric ply is cut and layed-up as an integral piece/layer.

The techniques described above for forming the fabric 500, which for example has a width of at least 100 mm, could also be used to form a tape having a lower width of less than 100 mm.

FIG. 6 illustrates a unidirectional (UD) stitched fabric 600 with tows, at least one of which corresponds to a tow containing cork thread, such as in the examples of FIGS. 1, 2 and 3, and according to an example embodiment of the present disclosure. In this example, the tows containing cork thread are for example arranged in strips 602 shown running vertically in FIG. 6, and a further thread 604 is woven across the strips 602 at regular intervals in order to join the strips 602 together. In the case of 0° UD fabrics, the strips 602 run along the length of the fabric, and the stitching is for example performed in the horizontal direction. In the case of 90° UD fabrics, the strips 602 run perpendicular to the length of the fabric, and the stitching is for example performed in the vertical direction. The further thread of the stitching is for example typically of polyester, although nylon, ramie, flax, or other materials may alternatively be used as desired. The fabric is unidirectional, as it is the tows that provide the strength along their axes and the “stitching” is used only to hold the position of the fibers until they are encapsulated in the matrix during the molding process of an FRC.

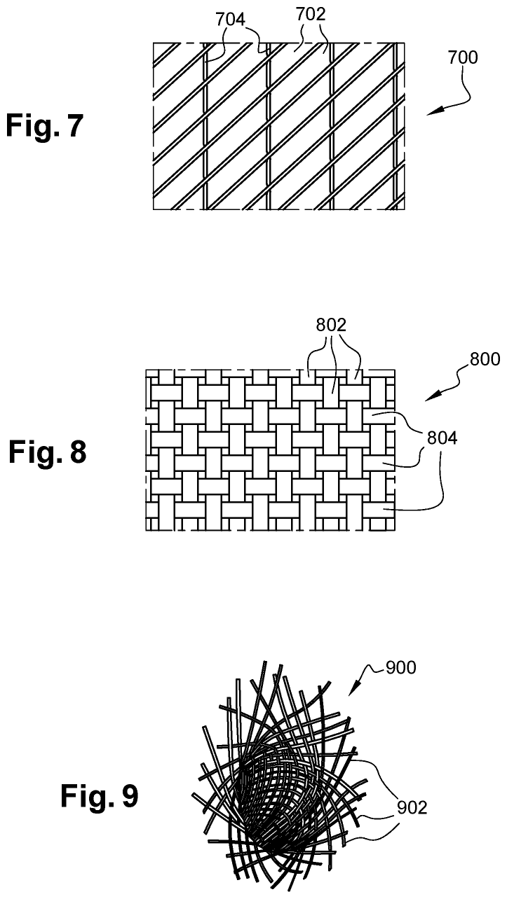

FIG. 7 illustrates a multi-axial stitched fabric composed of tows 702, at least one of which corresponds to a tow containing cork thread, such as in the examples of Figures 1, 2 and 3, and according to an example embodiment of the present disclosure. In this fabric, a machine is for example used to orient fibers at a specific angle, typically at 0°, 90°, +45°, and/or −45° (it is also possible to orient fibers in +/−60° angles on some machines). Fiber at a given angle is placed on a single layer, and the layers are situated one above the other and then the layers are stitched together in a 0° and/or 90° orientation to give structure to the fabric. Fabrics may be bi-axial (typically +45/−45), triaxial (0/+45/−45, 0/+60/−60 or 90/+45/−45), or quadriaxial (0/90/+45/−45). The stitching 704 is for example typically of polyester, although nylon, ramie, flax, or other materials may alternatively be used as desired.

FIG. 8 illustrates a multi-axial woven fabric comprising tows, at least one of which corresponds to a tow containing cork thread, such as in the examples of FIGS. 1, 2 and 3, and according to an example embodiment of the present disclosure. The example of FIG. 8 comprises tows 802 in the vertical direction, and tows 804 in the horizontal direction, the tows 802, 804 for example having substantially the same widths as each other.

FIG. 9 illustrates a tubular braid 900 comprised of reinforcement tows according to an example embodiment of the present disclosure. For example, such a braid 900 comprises tows 902, at least one of which corresponds to a tow containing cork thread, such as in the examples of FIGS. 1, 2 and 3.

While examples have been described of reinforcement fiber tows or rovings comprising cork threads, in alternatively embodiments one or more tows, or one or more rovings of a reinforcement fabric, may consist of only one or more cork threads, and may be combined with other reinforcement fiber tows that may or may not contain a cork thread.

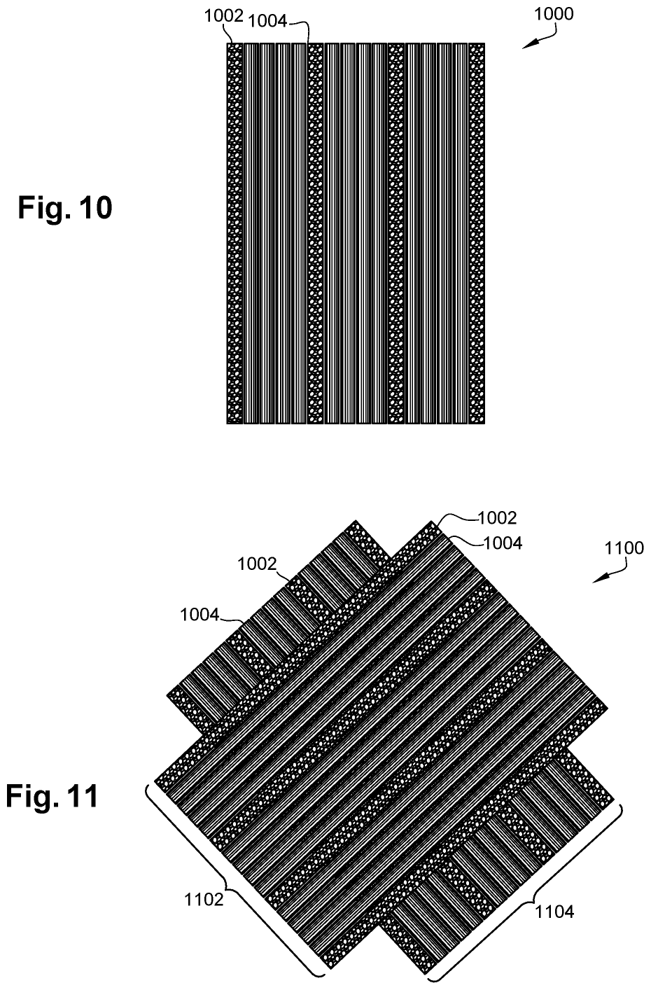

Furthermore, fabrics for a fiber-reinforced composite may be created in which at least one tow of the fabric consists only of cork thread, as will now be described in more detail with reference to FIGS. 10 to 13.

FIG. 10 illustrates a unidirectional fabric 1000 comprising at least one roving 1002 formed of cork thread, and other rovings 1004 formed of other materials, such as natural or synthetic tows. Examples of natural tows include tows formed of fiber such as vegetal fibers of bamboo, flax, ramie, hemp, sisal, jute, banana, pineapple leaf, coir, abaca, rice, corn and nanocellulose, such as mineral fibers of basalt, asbestos, and ceramic fibers, and such as animal-derived fibers of goat hair, horse hair, lamb wool, and silk, while examples of synthetic tows include tows formed of carbon, glass, boron or aramid In some embodiments, the natural fibers are organic fibers, or vegetable-derived fibers. This fabric can also incorporate, as described above, the same metal filaments, plastic or resin filaments, or other materials, which are or may become common to the production of FRCs.

The cork thread tows 1002 for example each have the same dimensions as the cork thread 102 used to form the tow in the examples of FIGS. 1, 2 and 3 above. Each cork thread tow 1002 may comprise a single cork thread, or a bundle of two or more cork threads.

The other tows 1004 for example have dimensions substantially the same as those of the cork thread tows 1002 to create a uniform fabric, or their dimensions could be different to that of the cork thread tows 1002 to create an non-uniform fabric. Each of the other tows 1004 is for example formed of bundles of two or more, and generally hundreds or thousands, of natural or synthetic fibers.

In the example of FIG. 10, the fabric 1000 comprises a parallel arrangement of tows providing a unidirectional fabric, and there is a cork tow 1002 between every group of four adjacent non-cork tows 1004. This ratio could however be changed, the number r of non-cork rovings 1004 in each group separated by a cork roving 1002 for example being between 1 and 100. The tows 1002 and 1004 are for example joined together to form a fabric in a similar manner to the techniques described above for fabrics 500 and 600 of FIGS. 5 and 6.

While in the example of FIG. 10 the tows are aligned in a single axis, it would also be possible to form a fabric using a similar technique to the one described above in relation with FIG. 5, but in which a non-woven matt is formed in which the cork thread tows 1002 and other tows 1004 are all just tangled together, like in the roving 300, and without a precise orientation.

FIG. 11 illustrates a biaxial fabric 1100 comprising tows arranged in two directions, which in the example of FIG. 11 are perpendicular directions, at least one tow for example being a cork tow formed of cork thread. For example, the fabric 1100 comprises two layers 1102, 1104 of unidirectional fabric, each of which for example corresponds to the fabric 1000 of FIG. 10. The layer 1102 for example lays on the layer 1104, the two layers for example being attached together in a similar manner to the fabric 700 of FIG. 7 described above. Similarly, as described in relation with FIG. 7, the multi-axial stitched fabric may be created with any similar arrangement of axes.

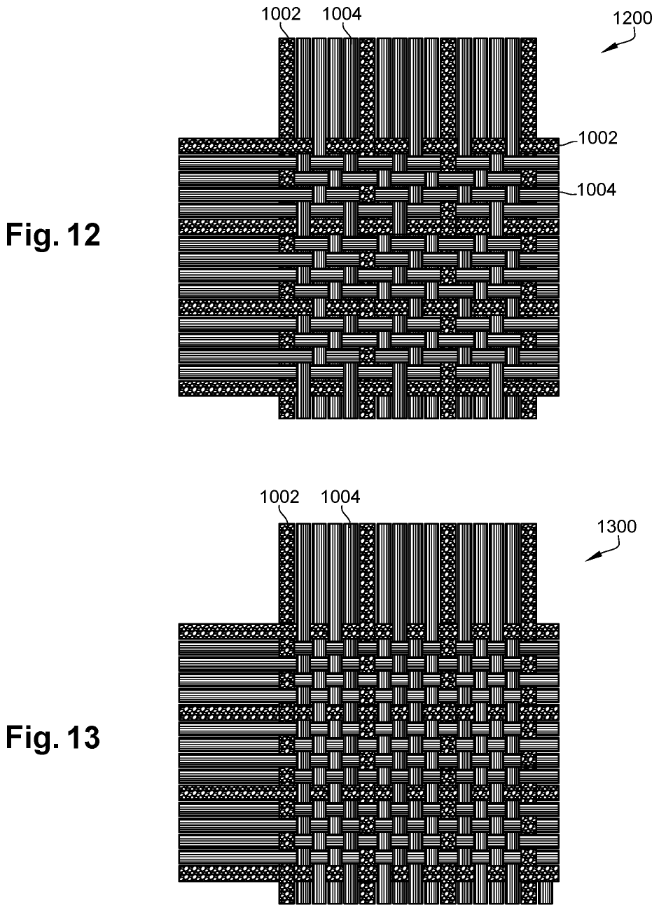

FIG. 12 illustrates a 2×1 twill fabric 1200 comprising tows formed of a cork thread according to an example embodiment of the present disclosure. For example, like the fabric of FIG. 11, the fabric 1200 of FIG. 12 comprises tows arranged in perpendicular directions, there being a cork tow 1002 between every group of r non-cork tows 1004 in each of the directions. However, in the example of FIG. 12, the tows are woven in a 2×1 twill pattern. The step of the twill pattern may vary according to the use of the fabric and may include, among others, patterns with a 2×1, 2×2, 2×3, 2×4, 3×1, 3×3, 3×4, etc. step. The distribution of cork tows may vary in the different axes.

FIG. 13 illustrates a plain weave fabric 1300 comprising tows formed of a cork thread according to an example embodiment of the present disclosure. The example of FIG. 13 is similar to the example of FIG. 12, except that the tows are woven in a plain weave pattern.

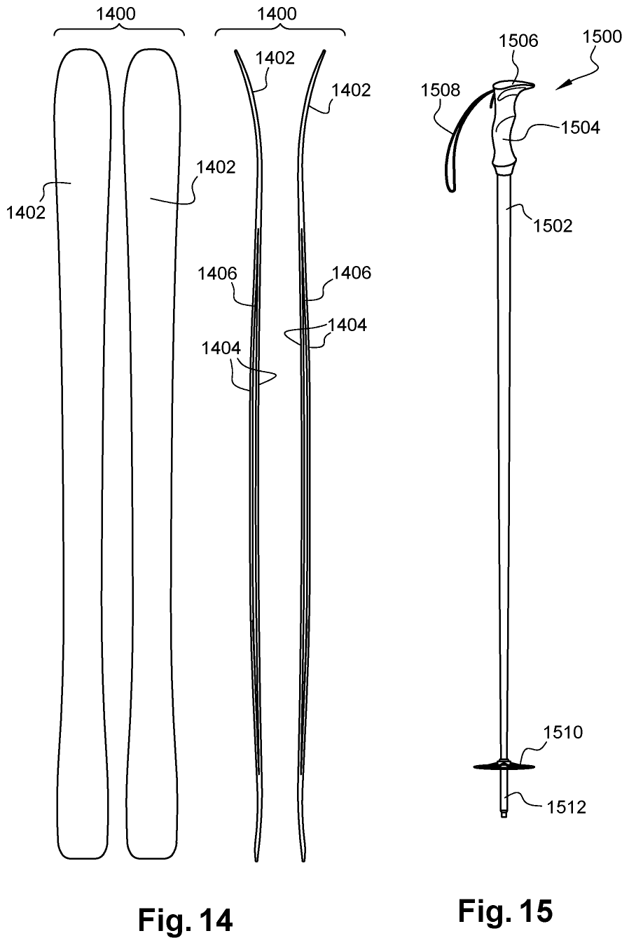

The fabrics and compositions described herein have many applications. For example, the fiber-reinforced composite as described herein could be used in a variety of applications in which sound, vibrational and/or rebound damping is beneficial, including for construction, bicycle frames, winter sports equipment, stereophonic equipment, aerospace components, etc. Example applications will now be described in more detail with reference to FIGS. 14 and 15.

FIG. 14 illustrates the sliding boards of a pair of skis 1400, each board 1402 being shown in front view and in side view in FIG. 14. As represented in the side view, the boards for example comprise one or more layers of ply 1404, and a core 1406 extending part way along the length of each board 1402. The ply 1404 of each board for example comprises a fiber-reinforced composition as described herein. Of course, The fiber-reinforced composition could equally be used to form a ply of other types of sliding board, such as a snow board or mono-ski, skateboard, etc.

FIG. 15 illustrates a ski pole 1500 comprising a shaft 1502. A grip formed of a grip body 1504, a grip head 1506 and a hand strap 1508 is disposed at one end of the shaft 1502. At the other end of the shaft 1502, a basket 1510 and a tip 1512 are provided. The shaft 1502 of the ski pole 1500 for example comprises a fiber-reinforced composition as described herein. Of course, other types of hand-held pole, such as a walking pole, could be formed in a similar manner.

### Second Aspect—Roving or Tow With Finite-Length Fibers and Continuous-Length Filaments

According to the first aspect above, a roving for a fiber-reinforced composite, or at least one tow for a fabric of a fiber-reinforced composite, is formed partially or entirely of cork thread.

According to a second aspect, rather than using cork thread, a roving for a fiber-reinforced composite, like the roving of FIGS. 1 to 3, or at least one tow for a fabric or of a fiber-reinforced composite, like a unidirectional tape, or a tow in the fabrics of FIGS. 5 to 13, is formed by a combination of finite length natural fibers and continuous filaments.

The natural fibers are for example formed of vegetal fibers of bamboo, flax, ramie, hemp, sisal, jute, banana, pineapple leaf, coir, abaca, rice, corn and nanocellulose, and animal-derived fibers of goat hair, horse hair, and lamb wool; or any other finite-length natural fiber with desirable mechanical properties for use in FRCs. In some embodiments, the natural fibers are organic fibers, or vegetable-derived fibers.

The continuous filaments are for example formed of extracted cellulose, nanocellulose filament, basalt filament, or other filaments which can be produced with a continuous structure on a macroscopic level for the entire length of the filament.

The use of finite length natural fibers, such as fibers of length greater than 10 mm and less than 2000 mm in length, provide damping properties and represent the range of fiber length most-common in rapidly-renewable fibers from vegetal sources with mechanical properties advantageous to the construction of FRCs. The continuous filaments, which for example have a continuous structure on a macroscopic level for the entire length of the filament, and extend continuously from one end of the roving or tow to the opposite, providing additional stability and strength to the FRC. An advantage of using a mixture of continuous filaments and finite length fibers is that the exclusive use of continuous filaments in a roving has an ecological impact due to the higher energy consumption to produce the continuous filaments or other source/fabrication issues. The use of natural, finite length fibers on the other hand can result in a roving that is carbon neutral or even carbon negative.

The ratio of finite length fibers to continuous filaments for the construction of rovings may preferably lie between 90:10 and 50:50 (+/−5) by volume depending on the use requirements of the reinforcement roving.

According to the second aspect, there is provided a roving for a fiber-reinforced composite, or a tow for a fabric of a fiber-reinforced composite, comprising a combination of finite-length natural fibers and continuous filaments.

According to one embodiment, the natural fibers are formed of Ramie or Flax or Pineapple Leaf Fiber, or more generally to organic fibers, or to vegetal fibers or vegetal-derived fibers.

According to one embodiment, the continuous fiber filaments are formed of extracted cellulose, nanocellulose, or basalt.

According to one embodiment, the natural fibers each have prepared length equal to or greater than 10 mm and less than 2000 mm.

According to one embodiment, the continuous filaments each have a length greater than 2000 mm.

According to a further aspect, there is provided a layup for a fiber reinforced composite comprising the above roving or tow.

According to yet a further aspect, there is provided a fiber reinforced composite comprising the above layup.

### Common Aspects

Various embodiments and variants have been described.

Those skilled in the art will understand that certain features of these embodiments can be combined and other variants will readily occur to those skilled in the art. For example, a fiber-reinforced composite could comprise one or more rovings according to the first aspect that include cork thread, and one or more rovings according to the second aspect that include finite-length fibers and continuous filaments. Alternatively, a fiber-reinforced composite could comprise a fabric reinforcement structure comprising one or more cork thread tows, and one or more tows formed according to the second aspect to include finite-length fibers and continuous filaments.

It will be apparent to those skilled in that art that the use of a cork thread as a tow or fiber-reinforced cork-thread tow may be used in only one axis of a fabric; it is not necessary to use it in each axis.

The tows for any fabric may be of different sizes, weights, densities, or fiber compositions. The axis of a multi-axial fabric (whether woven or non-woven) may utilize different fibers, multiple tow weights and dimensions, etc.

Furthermore, while some examples of fabrics have been described, the principles described herein could be applied to the construction, orientation and composition of any type of fabric formed of tows.

Finally, the practical implementation of the embodiments and variants described herein is within the capabilities of those skilled in the art based on the functional description provided hereinabove. In particular, there are numerous well-known fabrication processes for forming fiber-reinforced composites, and it will be apparent to those skilled in the art how the use of the rovings, tows, and fabrics described herein could be incorporated into any of these known fabrication processes.

1. A roving or fabric for a fiber-reinforced composite, comprising:
natural or synthetic fibers or rovings; and
one or more cork threads.

2. The roving or fabric of claim 1, wherein the one or more cork threads each have a diameter or width of less than 2 mm.

3. The roving or fabric of claim 1, wherein the one or more cork threads each have a length greater than 2000 mm, prior to cutting to form a fiber-reinforced composite layup.

4. The roving or fabric of claim 1, wherein the natural or synthetic fibers are formed of one or more of ramie, bamboo, pineapple leaf, flax, or hemp.

5. The roving or fabric of claim 1, wherein a volumetric percentage of the one or more cork threads in the roving is in the range 25% to 85%.

6. The roving or fabric of claim 1, wherein a volumetric percentage of the cork thread in the fabric is in the range 1% to 50%, and more preferably in the range 5% to 25%.

7. The roving or fabric of claim 1, wherein the natural or synthetic fibers are woven with the one or more cork threads.

8. (canceled)

9. The roving or fabric of claim 1, wherein the one or more cork threads are surrounded by the natural or synthetic fibers.

10. The roving or fabric of claim 1, wherein the one or more cork threads are at least partially disposed at an edge of the roving.

11. The roving or fabric of claim 1, wherein the one or more cork threads are tangled with the natural or synthetic fibers.

12. The roving or fabric of claim 1, combined with a thermoset or thermoform resin.

13. A sliding board comprising:
a first ply; and
a second ply coupled to the first ply, wherein at least one of the first ply or the second ply includes a roving or fabric including natural or synthetic fibers and one or more cork threads combined with a thermoset or thermoform resin.

14. A hand-held pole comprising:
a first end;
a second end; and
a shaft extending therebetween, the shaft including a roving or fabric including natural or synthetic fibers and one or more cork threads combined with a thermoset or thermoform resin.

15. A method of forming a roving or fabric for a fiber-reinforced composite comprising:
incorporating one or more cork threads into a roving or fabric comprising natural or synthetic fibers;
pre-impregnating the roving or fabric with an epoxy resin; and
arranging the roving or fabric upon a backing paper or support.

16. (canceled)

17. The method of claim 15, wherein the roving or fabric is a unidirectional fabric, the method further comprising forming one or more further unidirectional rovings or fabrics, and assembling the unidirectional rovings or fabrics to form a multi-axial fabric.

18. The method of claim 15, wherein arranging the roving or fabric upon the backing paper comprises tangling the roving or fabric to form a non-woven fabric.
